(19) United States
(12) Patent Application Publication
(10) Pub. No.: US 2015/0109194 A1
(43) Pub. Date: Apr. 23, 2015

(54) INFORMATION PROCESSING DEVICE, CONTROL METHOD THEREOF, AND PROGRAM

(71) Applicant: NEC CASIO Mobile Communications, Ltd., Kanagawa (JP)

(72) Inventor: Ryo Tamaoki, Kanagawa (JP)

(21) Appl. No.: 14/398,040

(22) PCT Filed: Dec. 27, 2012
(86) PCT No.: PCT/JP2012/083887

§ 371 Date: Oct. 30, 2014

(30) Foreign Application Priority Data
Jun. 28, 2012 (JP) 2012-145209

(51) Int. Cl. G06F 3/03

(52) U.S. Cl. CPC G06F 3/03
USPC 345/156

(57) ABSTRACT

An information processing device includes: an input unit that receives input; a detecting unit that detects the posture of the information processing device; and, a control unit that controls the operation of the information processing device in accordance with the posture of the information processing device which the detecting unit detects after confirming the presence or absence of a particular input via the input unit.

### TECHNICAL FIELD

The present invention relates to an information processing device, control method thereof, and program.

### BACKGROUND ART

In information processing devices such as mobile phones, and smart phones, operation input is generally performed via a touch panel or key buttons. Recently, in some information processing devices, an acceleration sensor for detecting the posture of the image processing device is provided so as to permit the user to perform operation input by changing the posture of the information processing device.

For example, Patent Document 1 (JP2012-033997A) discloses a technique for performing control of switching the information processing device from a first operation mode to a second operation mode when the information processing device is placed in a predetermined posture.

Further, a Non-patent Document 1 discloses a technique wherein when the user changes the posture of the information processing device by shaking or tilting the information processing device, a specific control is performed in accordance with the change in posture. According to these techniques, the user can perform more intuitive operation input compared to that via a touch panel or key buttons.

### RELATED ART DOCUMENTS

### Patent Documents

Patent Document 1: JP2012-033997A

### Non-Patent Documents

Non-patent Document 1: “Pictorially illustrated ‘Optimus bright L-07C’”, [Online], [Search on Jun. 13, 2012], Internet <URL: http://www.itmedia.co.jp/mobile/articles/1105/24/news017.html>

### SUMMARY OF THE INVENTION

### Problems to be Solved by the Invention

In the techniques disclosed in Patent Document 1 and Non-patent Document 1, the posture of the information processing device is used for operation control. In this case, to detect the posture of the information processing device, acceleration sensors, direction sensors and the like are used. In general, it is difficult to accurately detect difference in the posture of the information processing device by use of these sensors. Accordingly, if the operation of the information processing device is controlled based only on the posture of the information processing device, the number of the postures of the information processing device that can allocate control contents is limited, hence it is difficult to perform sensitive operation control.

The object of the present invention is to provide an information processing device, a control method thereof and program that can perform more sensitive operation control in accordance with the posture of the information processing device.

### Means for Solving the Problems

In order to achieve the above object, the information processing device of the present invention includes:

an input unit that receives input;

a detecting unit that detects the posture of the information processing device; and,

a control unit that controls the operation of the information processing device in accordance with the posture of the information processing device which the detecting unit detects after confirming the presence or absence of a particular input via the input unit.

In order to achieve the above object, the method of controlling an information processing device of the present invention includes:

receiving input via an input unit;

detecting the posture of the information processing device; and,

controlling the operation of the information processing device in accordance with the detected posture of the information processing device after confirming the presence or absence of a particular input via the input unit.

In order to achieve the above object, the program of the present invention causes a computer in an information processing device to execute:

a process of receiving input via an input unit;

a process of detecting the posture of the information processing device; and,

a process of controlling the operation of the information processing device in accordance with the detected posture of the information processing device after confirming the presence or absence of a particular input via the input unit.

According to the present invention, it is possible to preform operation control more sensitively in accordance with the posture of the information processing device.

### BRIEF DESCRIPTION OF THE DRAWINGS

FIG. 1 is a block diagram showing the essential configuration of an information processing device of the first exemplary embodiment of the present invention.

FIG. 2 is a block diagram showing the essential configuration of an information processing device of the second exemplary embodiment of the present invention.

FIG. 3 is a flow chart showing the operation of the operation control unit shown in FIG. 2.

### EXEMPLARY EMBODIMENTS

Exemplary embodiments for carrying out the present invention are next described with reference to the accompanying drawings.

### First Exemplary Embodiment

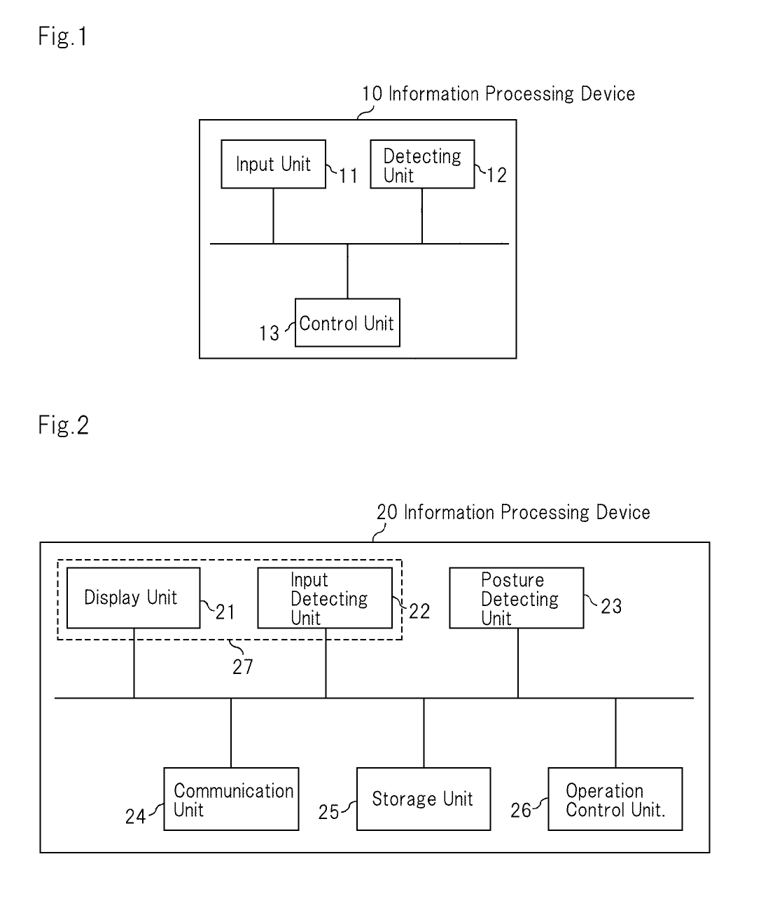

FIG. 1 is a block diagram showing the essential configuration of information processing device 10 of the first exemplary embodiment of the present invention. Here, specific examples of the information processing device according to the present invention may include mobile phones, smart phones, tablet PC (Personal Computer), notebook PC and PDA (Personal Data Assistant).

Information processing device 10 shown in FIG. 1 includes input unit 11, detecting unit 12 and control unit 13.

Input unit 11 receives input from the user. Here, specific examples of input unit 11 may include key buttons, and a touch panel that detects touch of input means such as fingers, a stylus pen, etc. and outputs a signal based on the position that the input means touches.

When input unit 11 is a touch panel, input unit 11 is composed of a display unit and a touch sensor laid over the display unit, not illustrated in FIG. 1. In this case, an operation image that shows operation content is displayed on the display unit. As the input means is touched in accordance with the display of the operation image, the touch sensor outputs a signal corresponding to the position at which the input means has touched, so that the operation content displayed at the position indicated by the signal is accepted as an input.

Here, if the touch sensor is one that detects touch of the input means from the change of the capacitance, it is also possible to detect the approach of the input means by adjusting the detection sensitivity of the change of the capacitance or the threshold of the change of the capacitance for determining the presence or absence of contact.

Detecting unit 12 detects the posture of information processing device 10 using acceleration sensors, direction sensors and others.

Control unit 13 controls the operation of information processing device 10 in accordance with the posture of information processing device 10 detected by detecting unit 12.

Next, the operation of information processing device 10 will be described focusing on the operation of control unit 13.

Control unit 13 controls the operation of information processing device 10 in accordance with the posture of information processing device 10 detected by detecting unit 12 within a predetermined period of time after confirmation of whether or not a particular input was made via input unit 11.

For example, in a case where a predetermined application is being executed, when information processing device 10 detected by detecting unit 12 is placed in a particular posture after a quit command of the application has been input as the particular input, control unit 13 terminates the application and displays the image that corresponds to execution of other applications. On the other hand, when information processing device 10 detected by detecting unit 12 is placed in a particular posture without any input of the quit command of the application, control unit 13 terminates the application and goes into sleep mode in which display of the display unit is turned off.

In this way, according to the present exemplary embodiment, information processing device 10 controls the operation of information processing device 10 in accordance with the posture of information processing device 10 which detecting unit 12 detects after confirming the presence or absence of a particular input via input unit 11.

The operation control of information processing device 10 based on the presence or absence of a particular input via input unit 11 and the posture of information processing device 10 after confirming the presence or absence of the particular input, makes it possible to perform more sensitive operation control in accordance with the posture of information processing device 10 than that when the operation control is performed based only on the posture of information processing device 10.

### The Second Exemplary Embodiment

FIG. 2 is a block diagram showing the essential configuration of information processing device 20 of the second exemplary embodiment of the present invention.

Information processing device 20 shown in FIG. 2 includes display unit 21, input detecting unit 22, posture detecting unit 23, communication unit 24, storage unit 25 and operation control unit 26.

Display unit 21, following the control of operation control unit 26, displays various images. Herein, display unit 21 is one example of the notifying unit.

Input detecting unit 22 is a touch sensor that detects touch of input means such as fingers, a stylus pen, etc. and outputs a signal based on the position that the input means touches. Input detecting unit 22 is laid over display unit 21 so as to form a touch panel as input unit 27. Input unit 27 corresponds to input unit 11 in the first exemplary embodiment. Here, the touch sensor, not only detects touch of the input means but also detect its approach.

Posture detecting unit 23 detects the posture of information processing device 20 using acceleration sensors, direction sensors and others. Posture detecting unit 23 corresponds to detecting unit 12 in the first exemplary embodiment.

Communication unit 24 can be connected to a plurality of communication networks such as 3G line networks, LTE (Long Term Evolution) line networks, Wi-Fi communication networks, and Internet communication networks, and connects to any one of communication networks among the plurality of available communication networks, following the control of operation control unit 26.

As operation control unit 26 executes an application, storage unit 25 stores information on the usage status of the application in accordance with execution of the application. Operation control unit 26 can execute various kinds of applications, such as a phone calling application for phone call, web page browsing application for browsing web pages, and photograph browsing application for viewing photograph. For example, when a phone calling application is executed, storage unit 25 stores information on the opposite party, date and time of the phone call and others as information relating to the usage status of the application. Further, when a web page browsing application is executed, storage unit 25 stores URLs (Uniform Resource Locator) of browsed web pages and the like as information relating to the usage status of the application. When a photography browsing application is executed, storage unit 25 stores information that indicates the browsed photographs and the like as the information relating to the usage status of the application. The information relating to the usage statues of applications stored in storage unit 25 is notified to the user by display on display unit 21 or by any other means.

Operation control unit 26 executes an application in accordance with the input via input unit 27 and makes display unit 21 display images in accordance with the execution of the application. The operation control unit 26 also controls the operation of information processing device 20 in accordance with the posture of information processing device 20, which posture detecting unit 23 detects after confirming whether or not a particular input has been made via input unit 27. Operation control unit 26 is one example of control unit 13 in the first exemplary embodiment.

Next, the operation of information processing device 20 of the present exemplary embodiment will be described focusing on the operation of operation control unit 26.

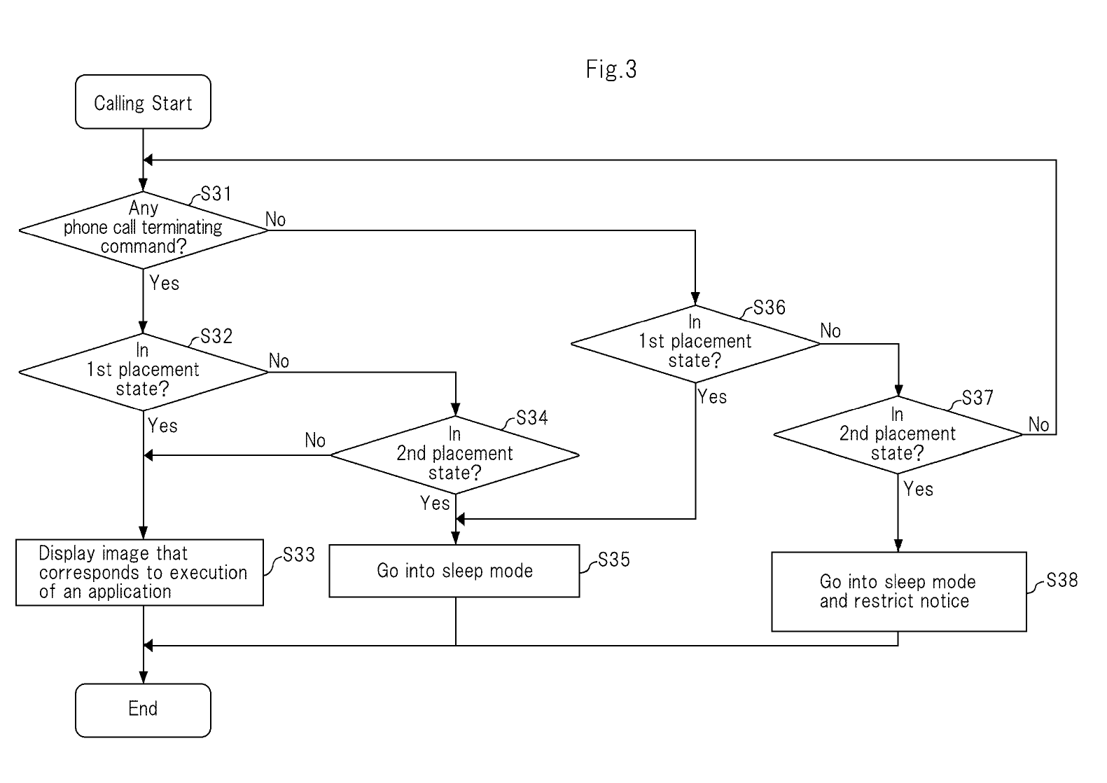

FIG. 3 is a flow chart showing the operation of control unit 26.

In the description hereinbelow, the state in which information processing device 20 is placed with display unit 21 vertically oriented upward is called the first placement state whereas the state in which information processing device 20 is placed with display unit 21 vertically oriented downward is called the second placement state.

Also it is assumed hereinbelow that operation control unit 26 has been directed to perform a phone call and executes a phone calling application. Storage unit 25 stores the opposite parties and date and time of the phone call as information relating to the usage status of the phone calling application.

In the phone calling state, operation control unit 26 periodically determines whether or not a phone call terminating command that indicates that the phone call has ended has been input via input unit 27 (Step S31).

When the phone call terminating command has been input (Step S31: Yes), operation control unit 26 determines whether or not the posture of information processing device 20 detected by posture detecting unit 23 within a predetermined period time after the input of the phone call terminating command is in the first placement state (Step S32).

When the posture of information processing device 20 is in the first placement state (Step S32: Yes), it can be considered that the user has put information processing device 20 on a desk or the like with display unit 21 vertically oriented upward after the end of the phone call. In such a situation, it is expected that the user will use another application next. Therefore, operation control unit 26 ends the telephone calling application and displays an image that corresponds to the execution of other applications on display unit 21 (Step S33).

When the posture of information processing device 20 is not in the first placement state (Step S32: No), operation control unit 26 determines whether or not the posture of information processing device 20 detected by posture detecting unit 23 is in the second placement state (Step S34).

When the posture of information processing device 20 is not in the second placement state (Step S34: No), it can be considered that the user will hold information processing device 20 and use another application after the end of the phone call. Accordingly, operation control unit 26 enters the process at Step S33 to display an image that corresponds to the execution of the application on display unit 21.

When the posture of information processing device 20 is in the second placement state (Step S34: Yes), it can be considered that the user has put information processing device 20 on a desk or the like with display unit 21 vertically oriented downward after the end of the phone call. In such a situation, it is unlikely to expect that the user will use another application next. Therefore, operation control unit 26 ends the telephone calling application and turns off display of display unit 21 and goes into sleep mode (Step S35).

When the phone call terminating command has not been input (Step S31: No), operation control unit 26 determines whether or not the posture of information processing device 20 detected by posture detecting unit 23 is in the first placement state (Step S36).

When the posture of information processing device 20 is in the first placement state (Step S36: Yes), it can be considered that in order to promptly terminate phone call, the user has put information processing device 20 on the desk or the like with display unit 21 vertically oriented upward from the state in which the user held information processing device 20 for phone call. Accordingly, operation control unit 26 enters the process at Step S35 to terminate the telephone calling application and turns off display of display unit 21 and goes into sleep mode.

When the posture of information processing device 20 is not in the first placement state (Step S36: No), operation control unit 26 determines whether or not the posture of information processing device 20 detected by posture detecting unit 23 is in the second placement state (Step S37).

When the posture of information processing device 20 is in the second placement state (Step S37: Yes), operation control unit 26 terminates the telephone calling application and turns off display of display unit 21 to go into sleep mode. Further, operation control unit 26 restricts notice of the information relating to the usage status of the telephone calling application stored in storage unit 25 as a result of the usage of the telephone calling application at this time (Step S38). Accordingly, operation control unit 26, if requested to provide notification of the information relating to the usage status of the telephone calling application, restricts display of the information relating to the usage status of the telephone calling application, on display unit 21 unless, for example a predetermined password or the like is entered.

When information processing device 20 is put in the second placement state without receiving a phone call terminating command, it is considered that the user has put information processing device 20 with display unit 21 vertically oriented downward from the state in which the user held information processing device 20 for phone call in order to promptly terminate the phone call and prevent display of display unit 21 from being seen by a third person. Accordingly, operation control unit 26 terminates the telephone calling application and goes into sleep mode, and at the same time, restricts notice of the information relating to the usage status of the telephone calling application at this time.

When the posture of information processing device 20 is not in the second placement state (Step S37: No), operation control unit 26 returns to the process at Step S31.

The description with FIG. 3 has been made by giving an example where a different operation control is performed depending on the determined placement state, by determining whether the posture of information processing device 20 is in either the first state or the second placement state. However, three or more placement states of information processing device 20 may be introduced to perform different operation controls.

Further, although the description with FIG. 3 has been made by giving an example where a telephone calling application is used, the present invention can be applied to case where a web page browsing application is used and other cases. In the case where a web page browsing application is used, URL of browsed web pages are stored in storage unit 25 as information relating to the usage status of the web application. In this case, notice of the information relating to the usage status of the web application can be restricted when information processing device 20 is placed in a predetermined posture during the usage of the web page browsing application.

Further, though the description with FIG. 3 has been described by giving an example where notice of the information relating to the usage status of the application is restricted, a configuration is also provided in which the information relating to the usage status of the application is deleted from storage unit 25.

In this way, according to the present exemplary embodiment, information processing device 20 controls the operation of information processing device 20 in accordance with the posture of information processing device 20 which posture detecting unit 23 detects after confirming the presence or absence of a particular input.

The operation control of information processing device 20 based on the presence or absence of a particular input and the posture of information processing device 20 after confirming the presence or absence of the particular input, makes it possible to perform more sensitive operation control in accordance with the posture of information processing device 20 than that when the operation control is performed based only on the posture of information processing device 20.

Here, though the present exemplary embodiment has been described by providing an example where notice is given by displaying the information relating to the usage status of the application stored in storage unit 25, on display unit 21, notice may be given by, for example, voice output using a speaker or the like.

Further, though the present exemplary embodiment has been described by giving an example where notice of the information relating to the usage status of the application is restricted, the present invention can also be applied to, for example, simplifying the input of settings required to execute applications.

As described above, communication unit 24 can be connected to a plurality of communication networks such as mobile phone networks, Wi-Fi communication networks and Internet communication networks. Now, it is assumed hereinbelow that the use fee for mobile phone networks are more expensive and have a lower communication rate than the Internet communication networks.

It is also assumed hereinbelow that as the telephone calls using information processing device 20, phone call using telephone numbers corresponding to mobile phone networks and phone call using IP (Internet Protocol) via the Internet communication networks, are permitted.

It is also assumed hereinbelow that information processing device 20 performs communication via the mobile phone network or via the Internet communication networks in order to update diverse functions of its own device or to automatically update the information stored on its own device.

Herein, if automatic updating is performed using the mobile phone network, the use charge may become prohibitive. To deal with, the user may set up the information processing device such that it will use the Internet communication network as the ordinary connection and will connect to the mobile phone network only for cases where the mobile phone network has to be used, for example, when a phone call using a telephone number corresponding to the mobile phone network is made. However such setting is troublesome for the user.

To avoid this, operation control unit 26 may be adapted to make communication unit 24 cut off connection with the mobile phone network and set up connection with the Internet communication networks from this point forwards when, for example a phone call terminating command is input during a phone call via the mobile phone network and when the posture of information processing device 20 is set in the second placement state. This arrangement causes the Internet networks to perform updating without it being necessary for the user to adjust any settings.

As a result, the user is able to use the mobile phone network that would be cost prohibitive only when making phone calls using telephone numbers corresponding to the mobile phone network and can use the Internet communication network that is available at low price or a fixed price, for communications other than the phone calls using telephone numbers corresponding to the mobile phone network, by terminating the phone call by setting information processing device 20 at the posture of the second placement state, without performing connection settings.

The method that is carried out in the information processing device of the present invention may be applied to a program that is executed by a computer. In addition, this program can be stored on a recording medium, and further, can be provided to the outside by way of a network.

Although the invention of the present application has been described with reference to exemplary embodiments, the present invention is not limited to the above-described exemplary embodiments. The configuration and details of the invention of the present application are open to various modifications within the scope of the invention of the present application that will be clear to one of ordinary skill in the art.

The present application claims priority based on Japanese Patent Application No. 2012-145209, filed on Jun. 28, 2012, the entire content of which is incorporated herein by reference in its entirety.

The whole or part of the above-described exemplary embodiments disclosed above can be described as, but limited to, the following supplementary notes.

### (Supplementary Note 1)

An information processing device comprising:

an input unit that receives input;

a detecting unit that detects the posture of the information processing device; and,

a control unit that controls the operation of the information processing device in accordance with the posture of the information processing device which the detecting unit detects after confirming the presence or absence of a particular input via the input unit.

(Supplementary note 2)

The information processing device according to Supplementary note 1, wherein the control unit, after confirming the presence or absence of a particular input via the input unit, determines, from among a plurality of predetermined postures, the posture that corresponds to posture of the information processing device detected by the detecting unit, and controls the operation of the information processing device in a different mode in accordance with the posture of the information processing device which the detecting unit has detected from the predetermined plural postures.

(Supplementary note 3)

The information processing device according to Supplementary note 1 or 2, further comprising: a display unit, wherein

during an execution of an application corresponding to an input via the input unit, if the posture of the information processing device which the detecting unit detects after input of a command to terminate the application via the input unit is placed in a predetermined posture, the control unit terminates the application and causes the display unit to display an image that corresponds to the execution of other applications, whereas if the posture of the information processing device which the detecting unit detects is placed in the predetermined posture without receiving any input command to terminate the application, the control unit terminates the application and turns off the display unit.

(Supplementary note 4)

The information processing device according to Supplementary note 3, wherein the particular posture is a posture with the display unit vertically oriented upward.

(Supplementary note 5)

The information processing device according to Supplementary note 1 or 2, further comprising:

a display unit;

a storage unit that, when an application is executed by the control unit in accordance with an input via the input unit, stores information relating to the usage status of the application; and,

a notifying unit that gives notice to the user, wherein

during an execution of an application corresponding to an input via the input unit, if the posture of the information processing device which the detecting unit detects after receipt of an input command to terminate the application via the input unit is placed in a predetermined posture, the control unit terminates the application and turns off display of the display unit, whereas if the posture of the information processing device which the detecting unit detects is placed in the predetermined posture without receiving any input command to terminate the application, the control unit terminates the application, turns off display of the display unit and restricts notice of the information relating to the usage status of the application stored in the storage unit via the notifying unit.

(Supplementary note 6)

The information processing device according to Supplementary note 5, wherein the particular posture is a posture with the display unit vertically oriented downward.

(Supplementary note 7)

The information processing device according to Supplementary note 5 or 6, wherein if the posture of the information processing device which the detecting unit detects is placed in the predetermined posture without receiving any input command to terminate the application via the input unit, the control unit deletes the information relating to the usage status of the application stored in the storage unit.

(Supplementary note 8)

The information processing device according to any one of Supplementary notes 1 to 7, wherein the control unit controls the operation of the information processing device in accordance with the posture of the information processing device which the detecting unit detects within a predetermined period of time after confirming the presence or absence of a particular input via the input unit.

(Supplementary note 9)

The information processing device according to Supplementary note 1, further comprising a communication unit that can be connected to a plurality of communication networks, wherein

during an execution of an application in connection with any one of the plurality of communication networks via the communication unit, if the posture of the information processing device which the detecting unit detects is placed in a predetermined posture without receiving any input command to terminate the application via the input unit, the control unit makes the communication unit cut off connection with the communication network, and sets up a communication network previously determined among the plurality of communication networks, as the communication network to which a connection is be connected.

(Supplementary note 10)

A control method of an information processing device comprising:

receiving input via an input unit;

detecting the posture of the information processing device; and,

controlling the operation of the information processing device in accordance with the detected posture of the information processing device after confirming the presence or absence of a particular input via the input unit.

(Supplementary note 11)

A program for causing a computer in an information processing device to execute:

a process of receiving input via an input unit;

a process of detecting the posture of the information processing device; and,

a process of controlling the operation of the information processing device in accordance with the detected posture of the information processing device after confirming the presence or absence of a particular input via the input unit.

1. An information processing device comprising:
an input unit that receives input;
a detecting unit that detects the posture of said information processing device; and,
a control unit that controls the operation of said information processing device in accordance with the posture of said information processing device which said detecting unit detects after confirming the presence or absence of a particular input via said input unit.

2. The information processing device according to claim 1, wherein said control unit, after confirming the presence or absence of a particular input via said input unit, determines, from among a plurality of predetermined postures, the posture that corresponds to posture of said information processing device detected by said detecting unit, and controls the operation of said information processing device in a different mode in accordance with the posture of said information processing device which said detecting unit has detected from the predetermined plural postures.

3. The information processing device according to claim 1, further comprising: a display unit, wherein
during an execution of an application corresponding to an input via said input unit, if the posture of said information processing device which said detecting unit detects after input of a command to terminate the application via said input unit is placed in a predetermined posture, said control unit terminates the application and causes said display unit to display an image that corresponds to the execution of other applications, whereas if the posture of said information processing device which said detecting unit detects is placed in the predetermined posture without receiving any input command to terminate the application, said control unit terminates the application and turns off said the display unit.

4. The information processing device according to claim 1, further comprising:
a display unit;
a storage unit that, when an application is executed by said control unit in accordance with an input via said input unit, stores information relating to the usage status of the application; and,
a notifying unit that gives notice to the user, wherein
during an execution of an application corresponding to an input via said input unit, if the posture of said information processing device which said detecting unit detects after receipt of an input command to terminate the application via said input unit is placed in a predetermined posture, said control unit terminates the application and turns off display of said display unit, whereas if the posture of said information processing device which said detecting unit detects is placed in the predetermined posture without receiving any input command to terminate the application, said control unit terminates the application, turns off display of said display unit and restricts notice of the information relating to the usage status of the application stored in said storage unit via said notifying unit.

5. The information processing device according to claim 4, wherein if the posture of said information processing device which said detecting unit detects is placed in the predetermined posture without receiving any input command to terminate the application via said input unit, said control unit deletes the information relating to the usage status of the application stored in said storage unit.

6. The information processing device according to claim 1, wherein said control unit controls the operation of said information processing device in accordance with the posture of said information processing device which said detecting unit detects within a predetermined period of time after confirming the presence or absence of a particular input via said input unit.

7. The information processing device according to claim 1, further comprising a communication unit that can be connected to a plurality of communication networks, wherein
during an execution of an application in connection with any one of the plurality of communication networks via said communication unit, if the posture of said information processing device which said detecting unit detects is placed in a predetermined posture without receiving any input command to terminate the application via said input unit, said control unit makes said communication unit cut off connection with the communication network, and sets up a communication network previously determined among the plurality of communication networks, as the communication network to which a connection is be connected.

8. A control method of an information processing device comprising:
receiving input via an input unit;
detecting the posture of said information processing device; and,
controlling the operation of said information processing device in accordance with the detected posture of said information processing device after confirming the presence or absence of a particular input via said input unit.

9. A non-transitory computer-readable recording medium having recorded therein a program for causing a computer in an information processing device to execute:
a process of receiving input via an input unit;
a process of detecting the posture of said information processing device; and,
a process of controlling the operation of said information processing device in accordance with the detected posture of said information processing device after confirming the presence or absence of a particular input via said input unit.

10. The information processing device according to claim 2, further comprising: a display unit, wherein
during an execution of an application corresponding to an input via said input unit, if the posture of said information processing device which said detecting unit detects after input of a command to terminate the application via said input unit is placed in a predetermined posture, said control unit terminates the application and causes said display unit to display an image that corresponds to the execution of other applications, whereas if the posture of said information processing device which said detecting unit detects is placed in the predetermined posture without receiving any input command to terminate the application, said control unit terminates the application and turns off said the display unit.

11. The information processing device according to claim 2, further comprising:
a display unit;
a storage unit that, when an application is executed by said control unit in accordance with an input via said input unit, stores information relating to the usage status of the application; and,
a notifying unit that gives notice to the user, wherein
during an execution of an application corresponding to an input via said input unit, if the posture of said information processing device which said detecting unit detects after receipt of an input command to terminate the application via said input unit is placed in a predetermined posture, said control unit terminates the application and turns off display of said display unit, whereas if the posture of said information processing device which said detecting unit detects is placed in the predetermined posture without receiving any input command to terminate the application, said control unit terminates the application, turns off display of said display unit and restricts notice of the information relating to the usage status of the application stored in said storage unit via said notifying unit.

12. The information processing device according to claim 2, wherein said control unit controls the operation of said information processing device in accordance with the posture of said information processing device which said detecting unit detects within a predetermined period of time after confirming the presence or absence of a particular input via said input unit.

13. The information processing device according to claim 3, wherein said control unit controls the operation of said information processing device in accordance with the posture of said information processing device which said detecting unit detects within a predetermined period of time after confirming the presence or absence of a particular input via said input unit.

14. The information processing device according to claim 4, wherein said control unit controls the operation of said information processing device in accordance with the posture of said information processing device which said detecting unit detects within a predetermined period of time after confirming the presence or absence of a particular input via said input unit.

15. The information processing device according to claim 5, wherein said control unit controls the operation of said information processing device in accordance with the posture of said information processing device which said detecting unit detects within a predetermined period of time after confirming the presence or absence of a particular input via said input unit.

16. The information processing device according to claim 10, wherein said control unit controls the operation of said information processing device in accordance with the posture of said information processing device which said detecting unit detects within a predetermined period of time after confirming the presence or absence of a particular input via said input unit.

17. The information processing device according to claim 11, wherein said control unit controls the operation of said information processing device in accordance with the posture of said information processing device which said detecting unit detects within a predetermined period of time after confirming the presence or absence of a particular input via said input unit.
